(19) United States
(12) Patent Application Publication
(10) Pub. No.: US 2011/0315803 A1
(43) Pub. Date: Dec. 29, 2011

(54) HARNESS LUG RING FOR OFFSHORE FISHING REEL

(76) Inventors: LORENS GEORGE HLAVA, Clinton, MO (US); CHRISTOPHER S. LITTAU, Bartlesville, OK (US)

(21) Appl. No.: 12/823,533

(22) Filed: Jun. 25, 2010

(51) Int. Cl. A01K 89/015

(52) U.S. Cl. 242/310

(57) ABSTRACT

An improved harness lug of increased strength for affixing a deep sea fishing reel to a harness tie. A fishing reel has a reel body having a frame that is affixed to a rod. A right lug ring and a left lug ring are adjacent to the right and left sides of the reel body, wherein the lug rings mate with the right and left sides of the reel body, respectively. Right and left lugs are integrally formed with the right and left lug rings, respectively. The lugs protrude from the reel body for receiving harness ties. Preferably, the right lug ring and the left lug ring have an outside diameter that is greater than the outside diameter of the frame for aesthetics and to protect the reel body. Right and left side covers are adjacent to an outside of the right and left lug rings.

### FIELD OF THE INVENTION

The invention relates to fishing reels. In particular, the invention relates to harness lug rings for use with offshore fishing reels.

### BACKGROUND OF THE INVENTION

Heavy duty fishing seats and harnesses are often used when deep sea fishing. Big game fishing chairs, often referred to as a “fighting chairs”, are mounted on a boat from which a fisherman will fight a big game fish. Big game fishing chairs are typically mounted on the stern or aft deck of a fishing boat to provide a station from which a fisherman can fight and land a big game fish. Typically a fighting chair has a seat, a back rest, a foot rest, and a pivoted rod holder for receiving the handle end of the fishing rod.

A typical big game fishing chair is pivotally mounted to the top of a support pedestal. Typically, the entire chair assembly is able to rotate about a vertical axis to permit the chair to move when a big game fish is caught by the fishing rod that is received in the rod holder affixed to the chair. The pivotal connection between the seat portion of the chair and the support pedestal provides for freedom of movement of the chair. Movement between the chair and the fisherman is facilitated by a “bucket”, or formed seat harness, in which the fisherman sits. The fishing rod is connected to the bucket by ties. The bucket is free to slide over the surface of the seat portion of the chair to allow the fisherman to move fore-and-aft by pushing with his feet against a foot rest. The sliding movement of the bucket results in a pivotal movement of the fishing rod about the rod holder due to the connection of the ties between the fishing rod and the bucket.

First ends of the ties are typically connected to the bucket. Second ends of the ties are typically affixed to harness lugs that protrude from the reel body affixed to the fishing pole. Harness lugs are typically small triangular or rectangular parts that are attached to the top crossbar of the reel frame by one of two screws.

Due to the large forces that can be encountered when attempting to reel in a very large catch, there are several disadvantages associated with the known prior art harness lug design. These disadvantages include deformation of the reel body structure under load and weakness and potential breakage associated with the small screws typically used to affix the ties to the harness lug bolts.

### SUMMARY OF THE INVENTION

This invention is directed to a lug on a deep sea fishing reel for receiving a harness tie, wherein the lug is incorporated into a ring that is integrated into the reel body. The harness lug ring of the invention is affixed to the frame by multiple screw bosses on the frame. The harness lug ring of the invention is further held to the frame by attachment of reel side covers that are screwed to the frame at multiple locations around the outer diameter of the frame.

The harness lug ring is made of a metal material and provides structural integrity to both the lug and the reel. The harness lug ring is preferably slightly larger in diameter than the frame and side covers, thus providing a degree of protection to the frame and side covers from impact. Additionally, the ring provides a decorative accent between the frame and side covers.

### BRIEF DESCRIPTION OF THE DRAWINGS

FIG. 1 is a perspective view of an offshore fishing reel utilizing the harness lug rings of the invention.

FIG. 2 is a plan view of a first harness lug ring shown in FIG. 1.

FIG. 3 is an end view of the harness lug ring of FIG. 2.

FIG. 4 is a plan view of a second harness lug ring shown in FIG. 1.

FIG. 5 is an enlarged view of a left hand version of the reel of FIG. 1 showing the first and second harness lug rings.

FIG. 6A is an enlarged exploded view of a portion of the reel of FIG. 5 showing a left side cover and adjacent first harness lug ring.

FIG. 6B is an exploded perspective view of a portion of the reel of FIG. 5 showing the reel frame and associated right side cover and second harness lug ring.

### DETAILED DESCRIPTION OF THE PREFERRED EMBODIMENTS

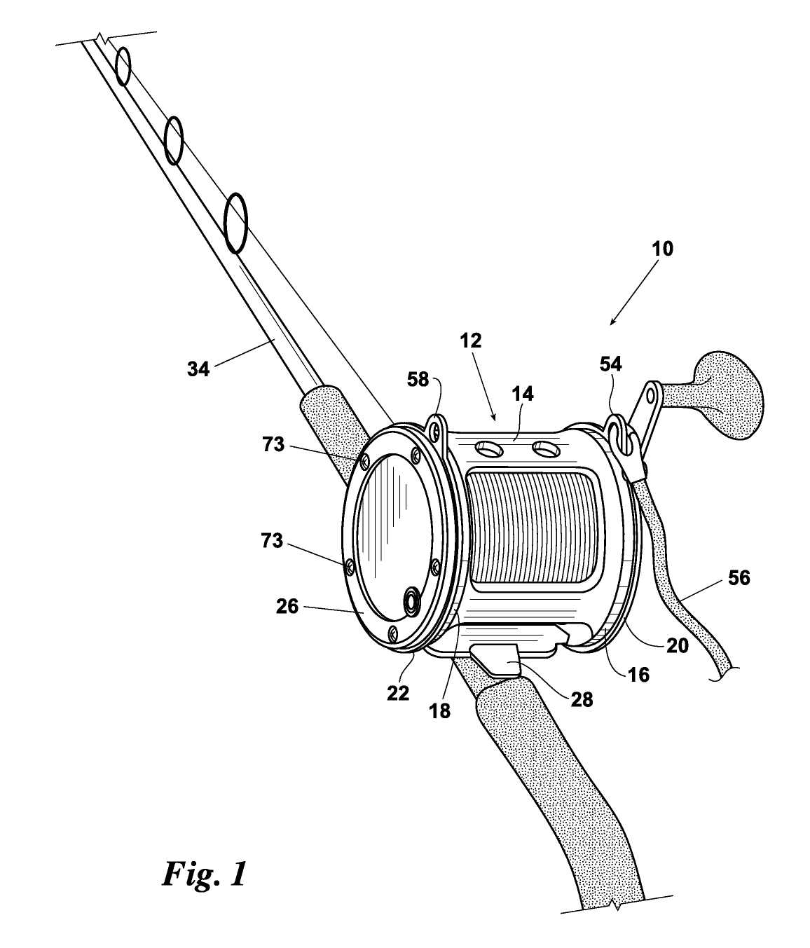

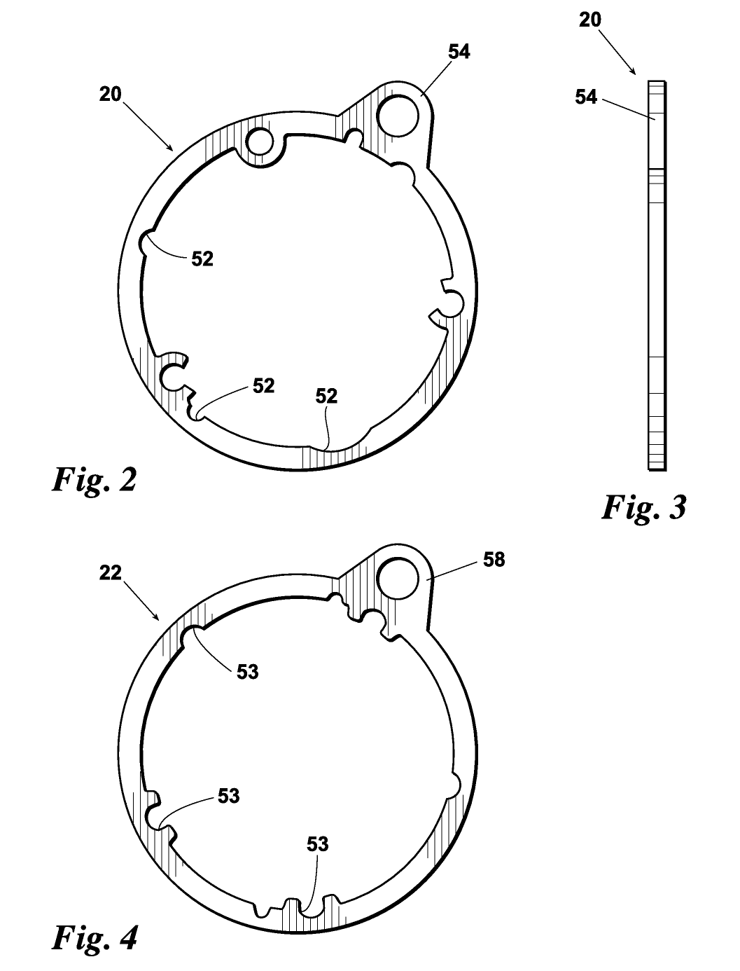

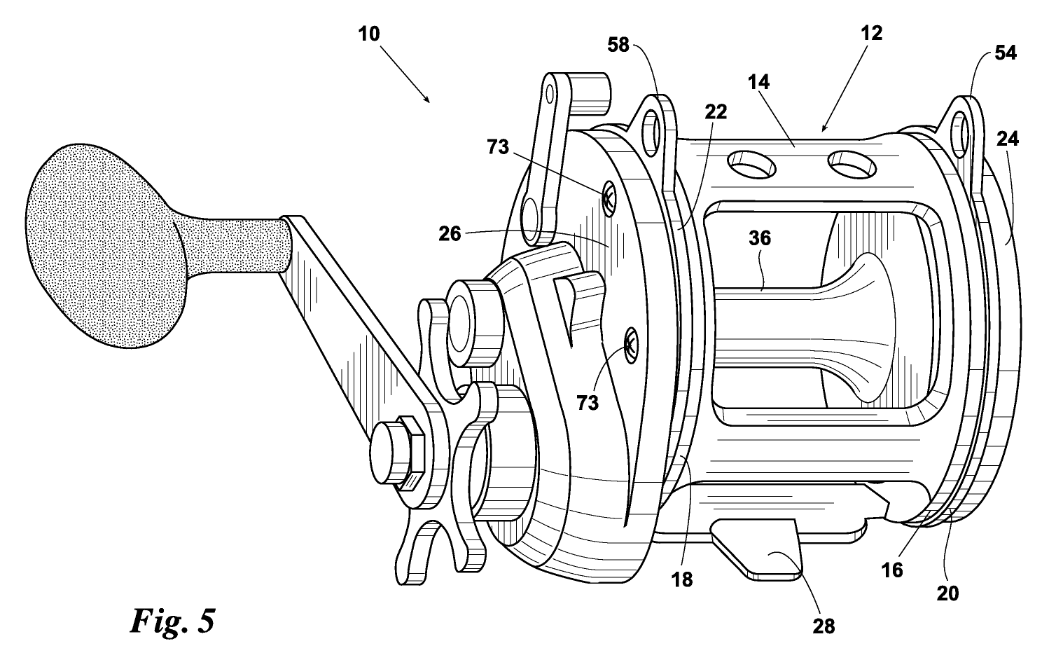

Referring now to FIGS. 1-6B, shown is a fishing reel designated generally 10. Fishing reel 10 includes a reel body designated generally 12. Reel body 12 has a frame 14, a right component plate 16, a left component plate 18, a right lug ring 20, a left lug ring 22, a right side cover 24, and a left side cover 26.

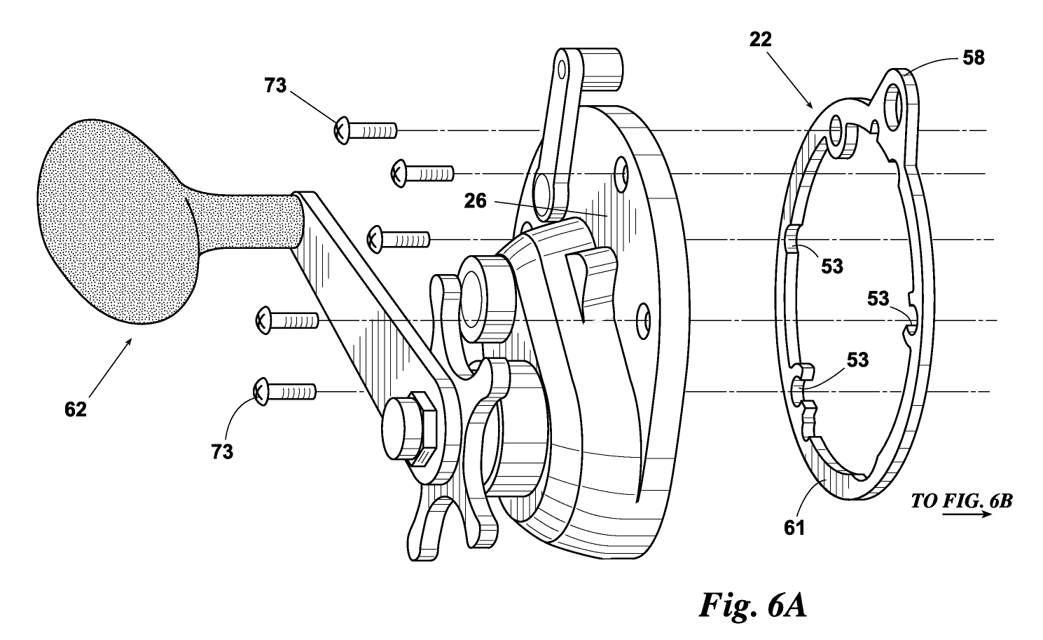

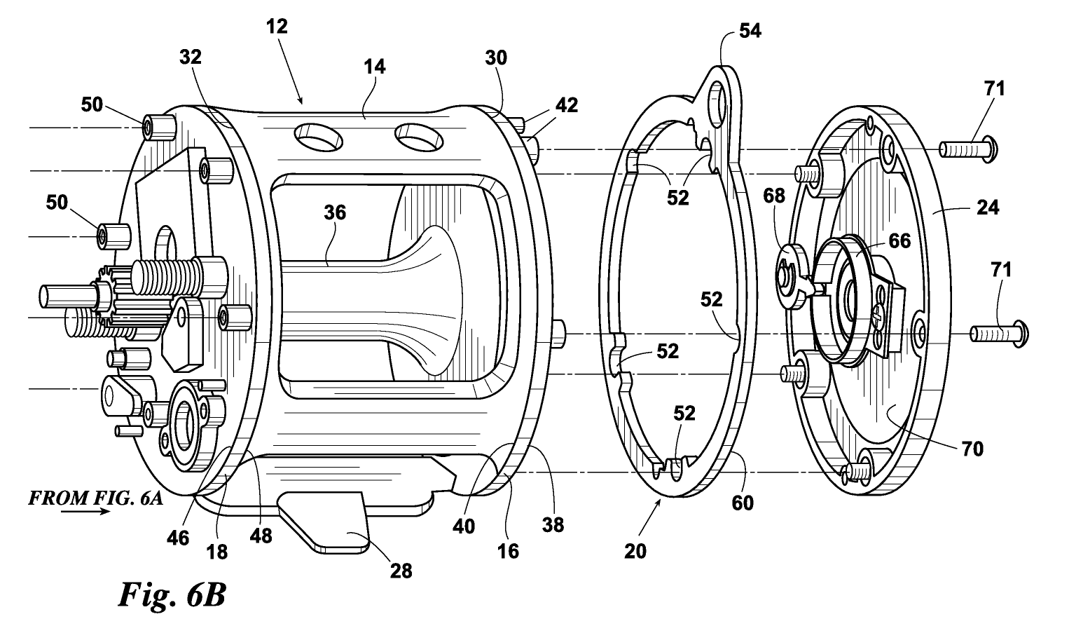

Frame 14 includes a foot 28 and has a right side 30, a left side 32 (FIG. 6B), and an outside diameter. Rod 34 (FIG. 1) is affixed to foot 28 of frame 14. Spool 36 is housed within frame 14.

Referring now primarily to FIG. 6B, right component plate 16 has an outside surface 38 and an inside surface 40. Right component plate 16 is affixed to right side 30 of frame 14. Right component plate 16 preferably defines a plurality of protrusions 42 on outside surface 38. Left component plate 18 has an outside surface 46 and an inside surface 48. Left component plate 18 is affixed to left side 32 of frame 14. Left component plate 18 preferably defines a plurality of protrusions 50 on outside surface 46.

Right lug ring 20 is preferably located adjacent to outside surface 38 of right component plate 16. Right lug ring 20 preferably defines a plurality of mating indentations 52 for mating engagement with the plurality of protrusions 42 on outside surface 38 of right component plate 16. Right lug ring 20 functions to disperse forces over a larger portion of right side 30 of frame 14 as compared to attaching a separate lug member to frame 14. In a preferred embodiment, right lug ring 20 forms a complete circle. However, right lug ring 20 may have a gap or otherwise be less than a complete circle.

Left lug ring 22 is preferably provided adjacent to outside 46 of left component plate 18. Left lug ring 22 preferably defines a plurality of mating indentations 53 for mating engagement with the plurality of protrusions 50 on outside surface 46 of left component plate 18. Left lug ring 22 functions to disperse forces over a larger portion of left side 32 of frame 14 as compared to attaching a separate lug member to frame 14. In a preferred embodiment, left lug ring 22 forms a complete circle. However, left lug ring 22 may have a gap or otherwise be less than a complete circle.

A right lug 54 is preferably integrally formed with right lug ring 20. Right lug 54 protrudes outwardly from reel body 12 to facilitate connection to right restraint or harness tie 56 (FIG. 1).

A left lug 58 is preferably integrally formed with left lug ring 22. Left lug 58 protrudes outwardly from reel body 12 to facilitate connection with left restraint or harness tie (not shown).

A right side cover 24 is affixed adjacent to outside surface 60 of right lug ring 20. Right side cover 24 may be provided with various orifices for attachment of various mechanisms such as spring 66 and clicker mechanism 68 on an inside surface 70 of right side cover 24. Right side cover 24 may also accommodate other devices. Fasteners, such as screws 71, affix right side cover 24 and right lug ring 20 to frame 14. Fasteners 71 preferably engage protrusions 42 of right component plate 16, but, alternatively, may pass through orifices formed in right lug ring 20, or may engage mating indentations 52 of right lug ring 20.

Left side cover 26 is adjacent to outside surface 61 of left lug ring 22. Left side cover 26 may support various devices including handle 62 and other devices. Fasteners, such as screws 73, affix left side cover 26 and left lug ring 22 to frame 14. Fasteners 73 preferably engage protrusions 50 of left component plate 18, but, alternatively, may pass through orifices formed in left lug ring 22, or may engage mating indentations 53 of left lug ring 22.

In a preferred embodiment, right lug ring 20 and left lug ring 22 have an outside diameter that is greater than an outside diameter of frame 14. Additionally, right lug ring 20 and left lug ring 22 have an outside diameter that is greater than right component plate 16 and left component plate 18. Additionally, right lug ring 20 and left rug ring 22 preferably have an outside diameter that is greater than that of left side cover 26 and right side cover 24. The large outside diameter of the lug rings 20, 22 provide a decorative aspect to the appearance of reel 10. Additionally, the larger outside diameter of the lug rings 20, 22 protect the reel 10 from impacts that might otherwise damage reel body 12.

In use, the right lug ring 20 and left lug ring 22 provide structural support to reel body 12. Right lug ring 20 and left lug ring 22 assist in preventing deflection of frame 14 under heavy loads that may be experienced during deep sea fishing conditions. Additionally, by forming right lug ring 20 with an integral right lug 54 and by forming left lug ring 22 with an integral left lug 58, greater structural integrity and strength may be achieved as compared to the prior art practice of attaching lugs via screws to a reel body.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the claims.

What is claimed is:

1. A fishing reel comprising:
a reel body having a frame having a right side and a left side, said frame having an outside diameter and a foot extending from said frame;
a rod affixed to said foot of said frame;
a spool housed within said frame;
a right lug ring adjacent to said right side of said reel body wherein said right lug ring mates with said right side of said reel body;
a left lug ring adjacent to said left side of said reel body wherein said left lug ring mates with said left side of said reel body;
a right lug integrally formed with said right lug ring and protruding from said reel body;
a left lug integrally formed with said left lug ring and protruding from said reel body.

2. The fishing reel according to claim 1 wherein:
said right lug ring and said left lug ring have an outside diameter that is greater than the outside diameter of said frame.

3. The fishing reel according to claim 1 wherein:
at least one of said right lug ring and said left lug ring defines a complete circle.

4. The fishing reel according to claim 1 wherein said reel body further comprises:
a right component plate having an outer side and an inner side, said right component plate affixed to said right side of said frame, said right component plate defining a plurality of protrusions on said outer side;
a left component plate having an outer side and an inner side, said left component plate affixed to said left side of said frame, said left component plate defining a plurality of protrusions on said outer side; and
wherein said right lug ring is adjacent to said outer side of said right component plate, said right lug ring defining a plurality of mating indentations for mating engagement with said plurality of protrusions on said outer side of said right component plate;
wherein said left lug ring is adjacent to said outer side of said left component plate, said left lug ring defining a plurality of mating indentations for mating engagement with said plurality of protrusions on said outer side of said left component plate.

5. The fishing reel according to claim 4 wherein:
said right lug ring and said left lug ring have an outside diameter that is greater than the outside diameter of said right component plate and of said left component plate.

6. The fishing reel according to claim 1 further comprising:
a left side cover adjacent to an outside of said left lug ring;
a right side cover adjacent to an outside of said right lug ring.

7. The fishing reel according to claim 6 wherein:
said right lug ring and said left lug ring have an outside diameter that is greater than the outside diameter of said left side cover and said right side cover.

8. A fishing reel comprising:
a reel body having a frame having a right side and a left side, said frame having an outside diameter and a foot extending from said frame;
a rod affixed to said foot of said frame;
a spool housed within said frame;
a right lug ring adjacent to said right side of said reel body wherein said right lug ring mates with said right side of said reel body;
a left lug ring adjacent to said left side of said reel body wherein said left lug ring mates with said left side of said reel body; and
said right lug ring and said left lug ring have an outside diameter that is greater than said outside diameter of said frame.

9. The fishing reel according to claim 8 further comprising:
a right lug integrally formed with said right lug ring and protruding from said reel body; and
a left lug integrally formed with said left lug ring and protruding from said reel body.

10. The fishing reel according to claim 8 wherein:
at least one of said right lug ring and said left lug ring defines a complete circle.

11. The fishing reel according to claim 8 wherein said reel body further comprises:
a right component plate having an outer side and an inner side, said right component plate affixed to said right side of said frame, said right component plate defining a plurality of protrusions on said outer side;
a left component plate having an outer side and an inner side, said left component plate affixed to said left side of said frame, said left component plate defining a plurality of protrusions on said outer side; and
wherein said right lug ring is adjacent to said outer side of said right component plate, said right lug ring defining a plurality of mating indentations for mating engagement with said plurality of protrusions on said outer side of said right component plate;
wherein said left lug ring is adjacent to said outer side of said left component plate, said left lug ring defining a plurality of mating indentations for mating engagement with said plurality of protrusions on said outer side of said left component plate.

12. The fishing reel according to claim 11 wherein:
said right lug ring and said left lug ring have an outside diameter that is greater than said outside diameter of said right component plate and of said left component plate.

13. The fishing reel of claim 8 further comprising:
a left side cover adjacent to an outside of said left lug ring;
a right side cover adjacent to an outside of said right lug ring.

14. The fishing reel of claim 8 wherein:
said right lug ring and said left lug ring have an outside diameter that is greater than said outside diameter of said left side cover and said right side cover.

15. A fishing reel comprising:
a reel body having a frame, a right component plate, a left component plate, a right lug ring, a left lug ring, right side cover and a left side cover;
a frame having a foot, a right side, a left side and an outside diameter;
a rod affixed to said foot of said frame;
a reel housed within said frame;
said right component plate having an outside and an interior side, said right component plate affixed to said right side of said frame, said right component plate defining a plurality of protrusions on said outside;
said left component plate having an exterior side and an interior side, said left component plate affixed to said left side of said frame, said left component plate defining a plurality of protrusions on said outside;
said right lug ring adjacent to said outside of said right component plate, said right lug ring defining a plurality of mating indentations for mating engagement with said plurality of protrusions on said outside of said right component plate;
said left lug ring adjacent to said outside of said left component plate, said left lug ring defining a plurality of mating indentations for mating engagement with said plurality of protrusions on said outside of said left component plate;
a right lug integrally formed with said right lug ring and protruding from said body;
a left lug integrally formed with said left lug ring and protruding from said reel body;
a left side cover adjacent to an outside of said right lug ring;
a right side cover adjacent to an outside of said left lug ring;
a spring and clicker mechanism affixed to an inside surface of said right side cover;
wherein said right lug ring and said left lug ring have an outside diameter that is greater than the outside diameter of said frame, of said right component plate, of said left component plate and of said left side cover and said right side cover.
